(19) United States
(12) Patent Application Publication
(10) Pub. No.: US 2002/0119849 A1
(43) Pub. Date: Aug. 29, 2002

(54) Bicycle chain manipulation tool

(76) Inventor: Robert Maynard, Bellevue, WA (US)

Correspondence Address: The Law Offices of Joseph Chalverus, Lake City Professional Center, 2611 N.E. 125th Street, Seattle, WA, 98125, US

(21) Appl. No.: 09/790,775

(22) Filed: Feb. 23, 2001

(51) Int. Cl. F16H 7/22

(52) U.S. Cl. 474/130

(57) ABSTRACT

A tool for manipulating bicycle drive chains having a central elongated portion with a first and second end formed to manipulate the drive chain while being held by the other end as a handle. On a first version, the first end is formed to grasp and pull the drive chain while the second end is formed to grasp and push the drive chain. Other versions of the tool provide for both ends to feature pulling ends, or both ends to feature pushing ends, or one end with a pushing or pulling end and the other end terminating as a straight element. Each version of the tool is fashioned to be small, compact and easily portable.

### BACKGROUND OF THE INVENTION

1. Field of the Invention

The present invention relates generally to hand tools, particularly to hand tools used to manipulate chain drives and more specifically to hand tools used to manipulate endless chain drives on bicycles.

2. Description of the Related Art

Simple hand tools are devices used to assist manipulation of things. Many simple hand tools exist relating to belts and drives. For example, U.S. Pat. No. 2,121,129 granted to M. K. Malone on Jun. 21, 1938 and U.S. Pat. No. 2,621,529 granted to J. N. Hawkins on Dec. 16, 1952 teach simple hand tools relating to belt drives having a specific shape for the dedicated purposes and their uses. U.S. Pat. No. 5,318,479 granted to Lawroske on Jun. 7, 1994 teaches a dedicated tool directed to the installation of belts on vacuum cleaners. More specifically to hand tools for chain driven bicycles, U.S. Pat. No. 4,681,557 granted to Hillman on Jul. 21, 1987 discloses a holder for bicycle chains used to assist the removal of the rear wheel without touching the chain. U.S. Pat. No. 5,588,169 issued on Dec. 31, 1996 and U.S. Pat. No. 5,655,242 issued on Aug. 12, 1997, both to Chuang teach combination tools relating to bicycle, a portion of each one relating to bicycle chain repair and adjustment.

Bicycling is an ever growing activity. The basic system of a pedal driven mobile comprise a front and rear wheel attached to the ends of a triangular-like frame supporting a seat and foot pedals. The pedals are part of a forward drive set with a endless drive chain linked to a rear drive cluster attached to the rear wheel. A handle bar is used to steer the front wheel.

The drive train comprises standard size links attached one to another to form a flexible metal closed chain loop of a length sufficient to span between the forward drive set and the rear drive cluster.

The forward drive set comprises several parallel ring gears or chain-wheel of various size gears with sprocket complementary to the links with a ring gear selector such as a front derailleur above the drive set to move the drive train from one ring gear to the other. The rear drive clusters also comprises several parallel ring gears of various sizes with similar sprockets, usually formed in a compact unit with gear selector system such as a real derailleur and drive train tension means. The drive chain tension means provides a constant urging to the endless chain drive to minimize jumping of the drive chain from one ring gear to another or even off the ring gear. The drive chain provides the power from the front gear set to the rear gear set.

The means to position the drive chain to a particular ring gear of the forward drive set and means to position the drive chain to a particular ring gear of the rear drive cluster are usually position forward of the rider for fast and easy gear changes.

To decrease wear and improve performance of the bicycle tenacious lubricants are often used and recommended to be placed on the drive chain, such as oils and greases. Lubrication assists the links on the chain to flex with respect to each other as the chain moves between the rear drive cluster and forward drive set and to decrease wear on the various gears. Unfortunately, these lubricants also incorporate dust, dirt and other contaminates, which over time tend to discolor the lubricants and makes touching the chain messy. The tenacity of the lubricants also discourages touching the drive elements with hands or fingers since contaminated lubricants will transfer onto the hands and fingers and are difficult to remove.

Nevertheless, on occasions, even for properly adjusted drive systems, the drive chain will jump from the sprockets on the ring gears, either from the forward drive set or from the rear drive cluster. The drive chain occasionally will become jammed between the ring gears of the rear drive or fall from the forward drive set or off the rear drive cluster. When this happens, the drive chain must be returned to the correct position on the sprockets on the forward drive set and rear drive cluster.

Small sticks or rags and such if handy are sometimes used to do this to avoid getting the hands messy. However, these are not always available nor designed to retrieve the chain should it be lodged between ring gears or completely off the gear rings.

More specifically, there has been a need for a tool designed to be used specifically for the purposes of returning the drive chain to the sprockets without getting the hands soiled or messy. The tool is also used to release the drive chain when should it be jammed.

Ideally this tool should be easy to use, lightweight, strong, portable and convenient. My tool described herein satisfies all these needs.

### BRIEF SUMMARY OF THE INVENTION

The present invention is embodied in an elongated central member with two useful features at the ends. On one version of my tool, the end of the elongated member has a concave portion to provide a pulling element used to surround the drive chain so it can be pulled. The other end of the central member provides a convex portion as a pushing element, used to surround the drive chain so it can be pushed. Both ends of this version assist in their respective advantages to release of a jammed drive chain from a gear cluster.

It will be seen that another version of my tool may feature both ends of the central elongated member to have a concave puller element. A third version of my tool features a convex pushing element on each end. Moreover, an additional version of my tool features a concave pulling element on one end of the elongated central member with the other end of the central member terminating as a straight element to be used as a handle. Likewise, another version of my tool has a convex pushing element on one end of the central member with the other end terminating as a straight element to be used as a handle. The concave pulling element is used as a puller element with the other end as a handle. The convex pushing element is used as a pushing element with the other end as a handle. Often times, the convex pushing element is used first to move the drive chain into a position where the concave pulling element can be used to return a drive chain to the proper position on the gear cluster.

In all these versions, the size of the tool permits the user to effectively grasp the links or push the links within the confines of the ring gears or gear cluster.

Accordingly, it is a general object of the present invention to provide a ideal tool to be used to return a bicycle drive chain to the gear sprocket set on either the forward ring gears or the rear drive cluster or to manipulate the drive chain from within the gear cluster or sprocket set that may have been jammed or stuck.

More specifically, it is an object of the present invention to provide a tool for the above purpose that is light weight and easy to use.

It is also an object to provide the above purposes constructed simply, easily and inexpensively.

It is another object of the present invention to attain the foregoing objects sufficiently durable to withstand routine handling and use without deterioration.

Further objects and advantages of my invention will become apparent from a consideration of the drawings and ensuing description thereof.

### BRIEF DESCRIPTION OF THE DRAWING

FIG. 1 is a perspective view of the tool with a pushing element at a near end and pulling element at the far end of the elongated holder aligned on the same plain.

FIG. 2 is a side view of the tool as shown in FIG. 1 with the puller element interacting with a drive chain with the arrow indicating the direction of pull of the tool.

FIG. 3 is a side view of the tool as shown in FIG. 1 with the pusher element interacting with the drive chain with the arrow indicating the direction of the push of the tool.

FIG. 4 is a side view of the tool as shown in FIG. 1 but with the pushing element rotated 180 degrees about the central axis.

FIG. 5 is a side view of the tool with a two pulling elements.

FIG. 6 is a perspective view of the puller element of the tool grasping the drive chain around a link;

FIG. 7 is a perspective view of the puller element of the tool grasping the drive chain through a link.

FIG. 8 is a side view of the tool as shown in FIG. 5 with one pushing element rotated 180 degrees about the central axis.

### DESCRIPTION OF THE PREFERRED EMBODIMENTS

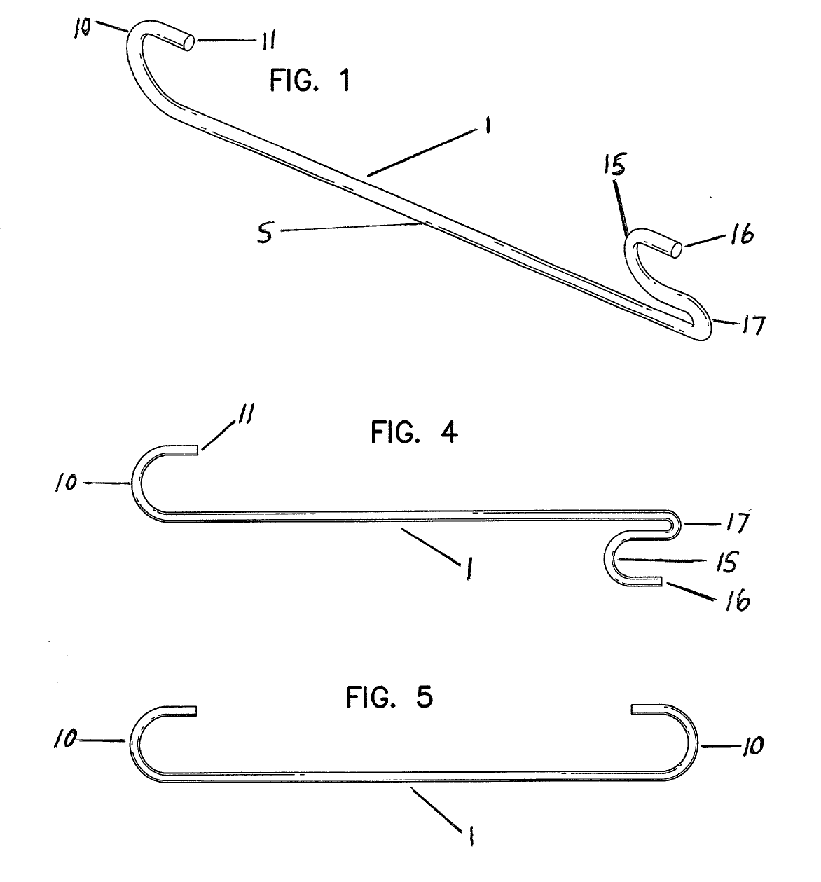

Referring to FIG. 1, my bicycle chain manipulation tool 1 comprises an elongated central member 5 with a puller element 10 at one end featuring an opening aligned in a direction towards the center of the tool 5 and a pusher element 15 at the other end, featuring an opening in the direction away from the center of the tool. The tool 1 can be formed from a single piece of metal wire of small diameter yet stiff enough to retain a shape under force, such as iron wire. The end of the puller element terminates substantially parallel to the central member 5 to permit the puller element or opening 10 to surround the chain even when stuck between gears. The pusher element 15 is formed from the end opposite the pusher element 10 by bending the wire back upon itself at 17 for a portion, then forming a semi circular curve of the pushing element 15 with the end of the member 16 substantially parallel to the central member 5. This permits the pusher element or opening 15 to surround the chain even when stuck between gears, as will be made clear below.

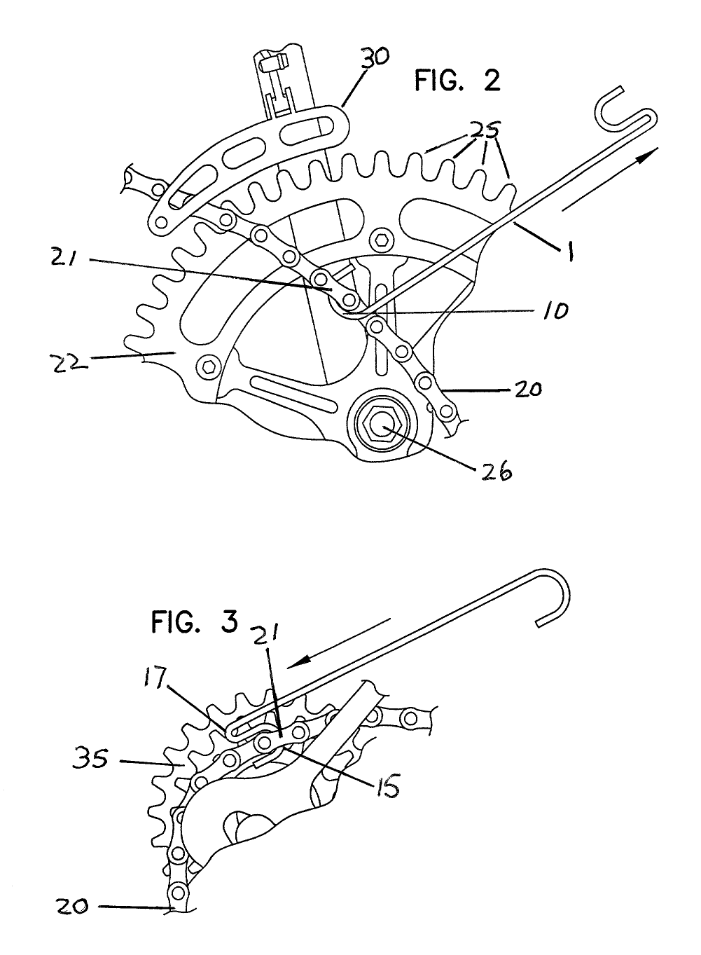

Referring to FIG. 2, the puller end 10 fits within the confines of the forward set of chain-wheels in order to interact with chain link 21 on the drive chain 20 that has fallen off the sprockets 25 near the chain-wheel drive axle 26 of the forward chain-wheel drive set 22. As can be seen in this FIG. 2, the tool 1 can be easily moved within the confines of the forward chain-wheel drive set 22 near the front derailleur 30 in the direction of the arrow to extract the chain drive 20 and return it to the sprockets 25 on the forward chain-wheels 22.

In a similar manner, as shown in FIG. 3 the pusher element 15 fits within the confines of the rear gear cluster 35 sometimes called a freewheel block. The semi circular portion of the pusher element 15 interacts with a chain link 21 on the drive chain 20 to move the chain 20 in the direction of the arrow to extract the chain 20 from the confines of the rear gear cluster 35.

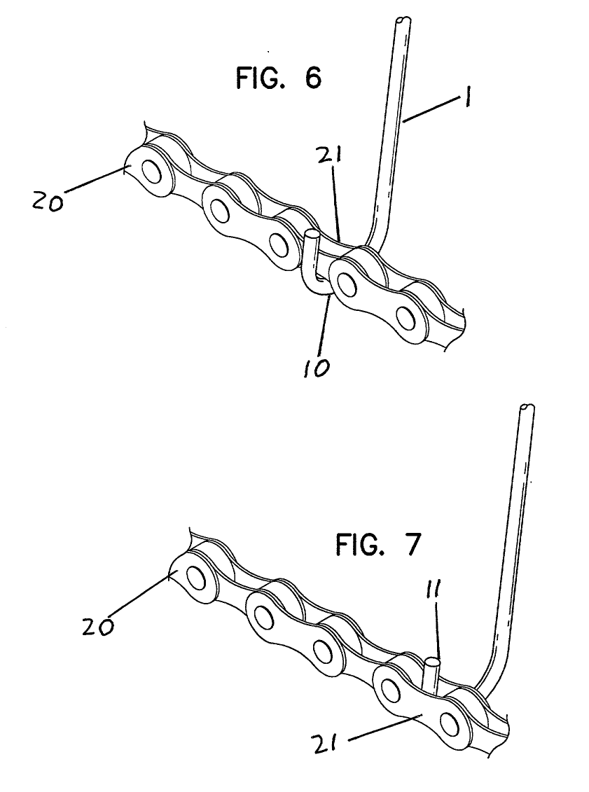

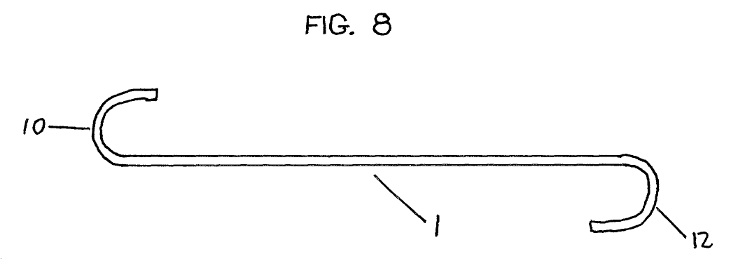

FIG. 6 and FIG. 7 show how the chain 20 can be lifted from a position intermediate of the rear gear cluster (not shown) and the forward chain-wheel (not shown). In FIG. 6, the semi circular puller element 10 surrounds the chain link 21 to pull the chain 20 while in FIG. 7, the puller end 11 is inserted within the link 21 to pull the chain 20. The unique features of my tool permit the semi circular pusher element 10 to move the chain into a position where the puller element 11 can be used to extract the chain.

My tool can be easily formed from soft iron extruded into 1/16 inch in diameter wire of the kind commonly used to construct coat hangers. It is an ideal material to form my tool since it can be cut to length and bent without too much work. An ideal length for the tool from the puller element 10 to the end of the loop at bend 17 is six inches, with the pulling element 10 and pushing element 15 to be one-half inch in width, formed by bending around a half-inch dowel, then cutting to conform to the shape of the tool as shown here. This size is large enough to grasp the tool while accessing the chain as needed, yet is small enough to fit conveniently into a pocket, be taped to the bicycle or stored with other bicycle tools.

Alternate Embodiments

There are many alternate embodiments of my invention that become clear after my invention is understood. While FIG. 1 features my invention with both the semi circular pulling element 10 and pushing element 17 are on the same plane with respect to the axis of the central member 5, FIG. 4 demonstrates another embodiment of my tool 1 with the pulling element 10 and pushing element 17 are aligned on opposition planes, that is, the pushing element 17 is rotated 180 degrees about the axis of the central member 5 with respect to the pulling element 10. Other alternate embodiments within the scope of my invention exist as shown in FIG. 5, where both ends feature a pulling element aligned on the same plane as each other or as shown in FIG. 8, pushing element 12 is aligned on a plain rotated 180 degrees about the central axis from the pulling element 10. Likewise, my tool could have both ends featuring a pushing element and the ends of the tool in a manner equivalent to the embodiment shown in FIG. 5 (not shown).

While the above description contains many specifications, there should not be construed as limitations on the scope of the invention, but rather as an exemplification of one preferred embodiment thereof and the many other variations that are possible within the scope of my invention. Accordingly, it should be understood that my invention should be understood not by the embodiment illustrated, but by the appended claims and their legal equivalents.

I claim:

1. A tool to manipulate an endless chain on a bicycle comprising:
an elongated central member having a near end and a far end;
a first open portion disposed at the far end;
a second open portion disposed at the near end;
said first and second portions sized to engage and manipulate said chain by movement of the central member.

2. The tool to manipulate an endless chain on a bicycle as claimed in 1 where said first open portion opens towards the near end to form a first puller and said second portion opens towards the far end to form a second puller.

3. The tool to manipulate an endless chain on a bicycle as claimed in 1 where said first portion opens towards the near end to form a puller and said second portion opens away from the far end to form a pusher.

4. The tool to manipulate an endless chain on a bicycle as claimed in 1 wherein said portions are substantially semi circular.

5. The tool to manipulate an endless chain on a bicycle as claimed in 2 where both open portions are aligned on the same plane.

6. The tool to manipulate an endless chain on a bicycle as claimed in 2 where said first portion is rotated 180 degrees about the central member from the second portion.

7. The tool to manipulate an endless chain on a bicycle as claimed in 3 where both open portions are on the same plane.

8. The tool to manipulate an endless chain on a bicycle as claimed in 3 where said first open portion is on a plane rotated 180 degrees from the plain of the second portion.

9. A tool to manipulate an endless chain on a bicycle comprising:
an elongated central member having a near end and a far end;
a first element disposed at the far end having an open portion;
a second element disposed at the near end having an open portion, said first and second elements sized to engage and pull said chain.

10. The tool to manipulate an endless chain on a bicycle as claimed in 9 where said portion of the first element opens towards said near end and said portion of the second element opens towards the near end.

11. The tool to manipulate an endless chain on a bicycle as claimed in 9 where said elements are on the same plane.

12. The tool to manipulate an endless chain on a bicycle as claimed in 9 where said first element on a plane rotated 180 degrees about the axis of the central member with respect to the second element.

13. The tool to manipulate an endless chain on a bicycle as claimed in 9 wherein said elements are substantially semi circular.

14. A method of making a tool to manipulate an endless chain on a bicycle comprising the steps of:
bending a far end of an elongated member into a curve to create a first opening;
bending a near end of the elongated member into a curve to create a second opening, each opening sized to engage and manipulate said chain.

15. The method of making a tool to manipulate an endless chain on a bicycle as described in claim 14 where the far end is bent so that the first opening faces the near end and the near end is bent so that the second opening faces the far end.

16. The method of making a tool to manipulate an endless chain on a bicycle as described in claim 14 where the far end is bent so that the first opening faces the near end and the near end is bent so that the second opening faces away from the far end.

17. The method of making a tool to manipulate an endless chain on a bicycle as described in claim 14 where said openings are bent in a semi circular fashion.

18. The method of making a tool to manipulate an endless chain on a bicycle as described in claim 14 where said openings are bent on the same plain.

19. The method of making a tool to manipulate an endless chain on a bicycle as described in claim 14 where said first opening is bent 180 about the axis of the elongated member with respect to the second opening.
